(19) United States
(12) Patent Application Publication
(10) Pub. No.: US 2012/0082051 A1
(43) Pub. Date: Apr. 5, 2012

(54) METHOD AND APPARATUS FOR CONTROLLING MEASUREMENT INFORMATION REPORT IN 3GPP SYSTEM

(75) Inventors: Sang Bum KIM, Seoul (KR); Himke Van Der VELDE, Zwolle (NL); Kyeong In JEONG, Suwon-si (KR); Gert-Jan VAN LIESHOUT, Apeldoorn (NL); Soeng Hun KIM, Yongin-si (KR)

(73) Assignee: SAMSUNG ELECTRONICS CO. LTD., Suwon-si (KR)

(21) Appl. No.: 13/252,390

(22) Filed: Oct. 4, 2011

Related U.S. Application Data
(60) Provisional application No. 61/389,481, filed on Oct. 4, 2010.
(60) Provisional application No. 61/389,501, filed on Oct. 4, 2010.

(30) Foreign Application Priority Data
Sep. 29, 2011 (KR) 10-2011-0099211

(51) Int. Cl. H04W 36/00; H04W 24/00

(52) U.S. Cl. 370/252

(57) ABSTRACT

A method and apparatus for recording and reporting Minimization of Drive Test (MDT) measurement information in a 3rd Generation Partnership Project (3GPP) system are provided. The method and apparatus includes supplementary information which is recorded and reported by the UE in connected/idle mode and useful for MDT performed by the User Equipment (UE). A process is provided for the location information acquisition time along with the location information in connected mode to verify the corresponding information and recording the measurement information at the cell reselection time in idle mode and the indicator information of the type of cell reselection. The information control method of a terminal includes measuring MDT information while the terminal is operating in idle mode and recording the MDT information in idle mode cell reselection.

### CROSS-REFERENCE TO RELATED APPLICATIONS

This application claims the benefit under 35 U.S.C. §119(e) of U.S. Provisional applications both filed on Oct. 4, 2010 in the U.S. Patent and Trademark Office and assigned Ser. Nos. 61/389,481 and 61/389,501, and under 35 U.S.C. §119(a) of a Korean patent application filed on Sep. 29, 2011 in the Korean Intellectual Property Office and assigned Serial No. 10-2011-0099211, the entire disclosures of each of which are hereby incorporated by reference.

### BACKGROUND OF THE INVENTION

1. Field of the Invention

The present invention relates to a method and apparatus for reporting measurement information. More particularly, the present invention relates to a method and apparatus for recording and reporting Minimization of Drive Test (MDT) measurement information in a 3rd Generation Partnership Project (3GPP) system.

2. Description of the Related Art

Mobile communication systems have been developed to enable users to communicate on the move. With the rapid advance of technology, mobile communication systems have evolved to a level capable of providing high speed data communication services as well as voice communication services. Recently, the 3rd Generation Partnership Project (3GPP), one of the next generation mobile communication standardization organizations, is in the progress of standardizing Long Term Evolution-Advanced (LTE-A). LTE-A is a high speed packet-based communication technology supporting a data rate higher than that of the current mobile communication technology.

With the evolution of the 3GPP standard, many discussions are being conducted for optimizing the radio network in addition to increasing data rate. In the initial radio network configuration or optimization stage, a base station or a base station controller should collect radio environment information related to its own cell coverage. This process is called a drive test. In a typical drive test, an operator carries the test apparatuses on a vehicle while performing the measurement task repeatedly. The measurement result is used to configure the system parameters of the base stations or base station controllers. The drive test increases total costs and time of the radio network optimization and maintenance. Study on minimization of drive tests and enhancement of radio environment analysis process and manual configuration is being conducted under the name of Minimization of Drive Test (MDT).

In order to accomplish the aforementioned purposes, User Equipment (UE) measures radio channels and reports the radio channel measurement information to an evolved Node B (eNB) periodically at an interval, immediately in response to a specific event, or after a predetermined time has elapsed from the time when the radio channel measurement information has been recorded, instead of performing the drive test. In the following description, the process for the UE to transmit the radio channel measurement information and other supplementary information to the eNB is called MDT measurement information report. The UE reports the channel measurement result after the completion of channel measurement while the communication is available with the eNB but delays the report while the communication is not available with the eNB until the connection to the eNB is recovered. The eNB uses the MDT measurement information received from the UE for cell coverage optimization.

### SUMMARY OF THE INVENTION

Aspects of the present invention are to address at least the above-mentioned problems and/or disadvantages and to provide at least the advantages described below. Accordingly, an aspect of the present invention is to provide the useful information recorded and reported by User Equipment (UE) performing Minimization of Drive Test (MDT) in connected/idled mode. Another aspect of the present invention is to define processes for transmitting the location information acquisition time along with the location information in connected mode to verify the validity of the corresponding information and for recording the measurement information at the cell reselection time point in idle mode and the indicator informing of the type of cell reselection.

In accordance with an aspect of the present invention, an information control method of a terminal is provided. The information control method includes measuring MDT information while the terminal is in an idle mode and recording the MDT information when the terminal performs cell reselection in the idle mode.

In accordance with another aspect of the present invention, an information control apparatus of a terminal is provided. The information control apparatus includes a controller for measuring MDT information while the terminal is in an idle mode and for recording the MDT information when the terminal performs cell reselection in the idle mode, and a memory for storing the recorded MDT information.

In accordance with another aspect of the present invention, an information reception method of a base station is provided. The method includes requesting MDT information recorded in an idle mode from a terminal, and receiving the recorded MDT information along with a type of cell reselection performed by the terminal, wherein the terminal measures the MDT information in the idle mode, records the MDT information and the type of the cell reselection when the terminal performs the cell reselection in the idle mode, and reports the recorded MDT information along with the type of the cell reselection when the terminal transitions from the idle mode to a connected mode.

In accordance with another aspect of the present invention, an information reception apparatus of a base station is provided. The information reception apparatus includes a transceiver for communicating with a terminal, and a controller for requesting MDT information recorded in an idle mode from a terminal, and for receiving the MDT information along with a type of cell reselection performed by the terminal, wherein the terminal measures the MDT information in idle mode, records the MDT information and the type of the cell reselection when the terminal performs the cell reselection in the idle mode, and reports the recorded MDT information along with the type of the cell reselection when the terminal transitions from the idle mode to a connected mode.

In accordance with another aspect of the present invention, a mobile terminal is provided. The mobile terminal includes a transceiver for communicating with an evolved Node B (eNB), a Global Navigation Satellite Systems (GNSS) receiver for receiving location information of the mobile terminal, a controller for measuring MDT information while the terminal is operating in an idle mode, and for recording the MDT information and the location information in an idle mode cell reselection, and a memory for storing the recorded MDT information and the location information.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a diagram illustrating a communication system in which Minimization of Drive Test (MDT) measurement is performed according to an exemplary embodiment of the present invention;

FIG. 2 is a signaling diagram illustrating an MDT measurement process of a deferred measurement report procedure according to an exemplary embodiment of the present invention;

FIG. 3 is a signaling diagram illustrating a procedure for reporting a recorded channel measurement information in response to a request of an evolved Node B (eNB) according to an exemplary embodiment of the present invention;

FIG. 4 is a diagram illustrating the principle of an immediate MDT report for collecting and reporting location information according to an exemplary embodiment of the present invention;

FIG. 5 is a signaling diagram illustrating a procedure for User Equipment (UE) to record channel measurement information and cell reselection type and report the recorded information to an eNB according to an exemplary embodiment of the present invention;

FIG. 6 is a flowchart illustrating a procedure for UE to report MDT measurement information according to an exemplary embodiment of the present invention; and

FIG. 7 is a block diagram illustrating a configuration of a UE according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding, but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but are merely used by the inventor to enable a clear and consistent understanding of the invention. Accordingly, it should be apparent to those skilled in the art that the following description of exemplary embodiments of the present invention is provided for illustration purposes only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

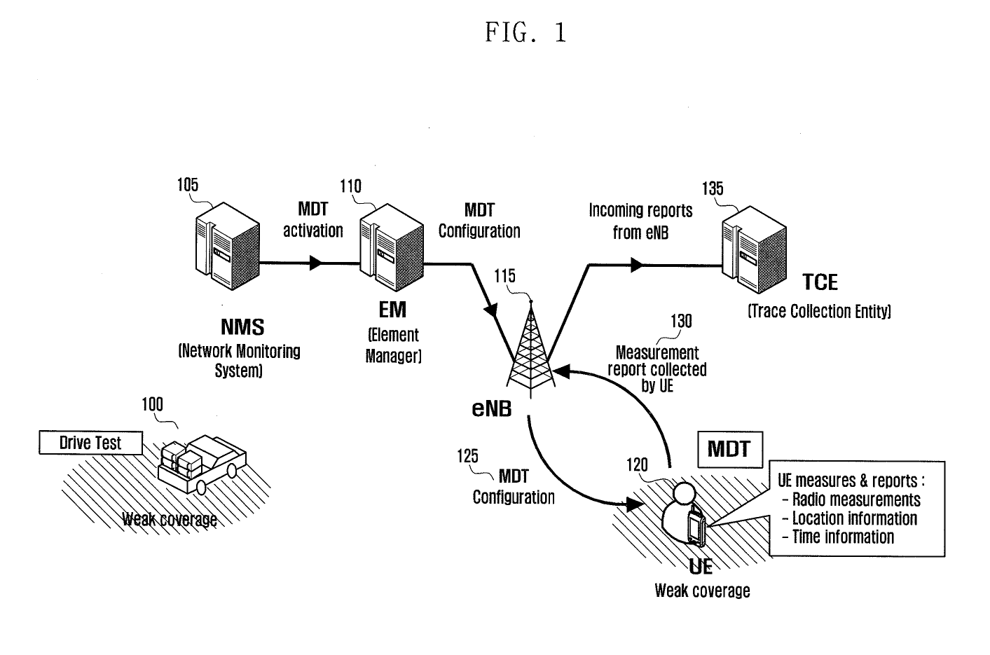

FIG. 1 is a diagram illustrating a communication system in which Minimization of Drive Test (MDT) measurement is performed according to an exemplary embodiment of the present invention.

Referring to FIG. 1, a typical drive test is performed in such a manner that a vehicle 100 carrying the measurement apparatus roams around the service areas to discover a shadow area and determines the signal condition. In MDT, however, User Equipment (UE) 120 performs the signal measurement instead of the vehicle-carried measurement apparatus. The Network Monitoring System (NMS) 105 can instruct the UE 120 to execute MDT. The NMS 105 provides the Element Manager (EM) 110 with any needed configuration information. The EM 110 sends the MDT configuration information to the eNB 115. The eNB 115 sends the MDT configuration information 125 to the UE 120 to instruct MDT. The UE 120 collects the MDT measurement information. The MDT measurement information may include the location and time information as well as the signal measurement information. The collected information 130 is reported to the eNB 115. The eNB 115 sends the collected information to the Trace Collection Entity (TCE) 135. The TCE 135 is a server for collecting MDT measurement information. The basic MDT measurement information report operations according to the Radio Resource Control (RRC) state of the UE are summarized as shown in Table 1.

TABLE 1

| | MDT measurement information |
|---|---|
| RRC state of UE | report operation of UE |
| Idle mode | Logging and deferred reporting |
| Connected mode | Immediate reporting |

In Table 1, the state where the UE does not communicate with the eNB is referred to as idle mode, and the state where the UE may communicate with the eNB is referred to as connected mode. In the idle mode, the UE records the channel measurement information. When the RRC state of the UE transitions from the idle mode to the connected mode, the UE reports the channel measurement information recorded in idle mode to the eNB. In the connected mode, the UE records the channel measurement information and reports the information immediately.

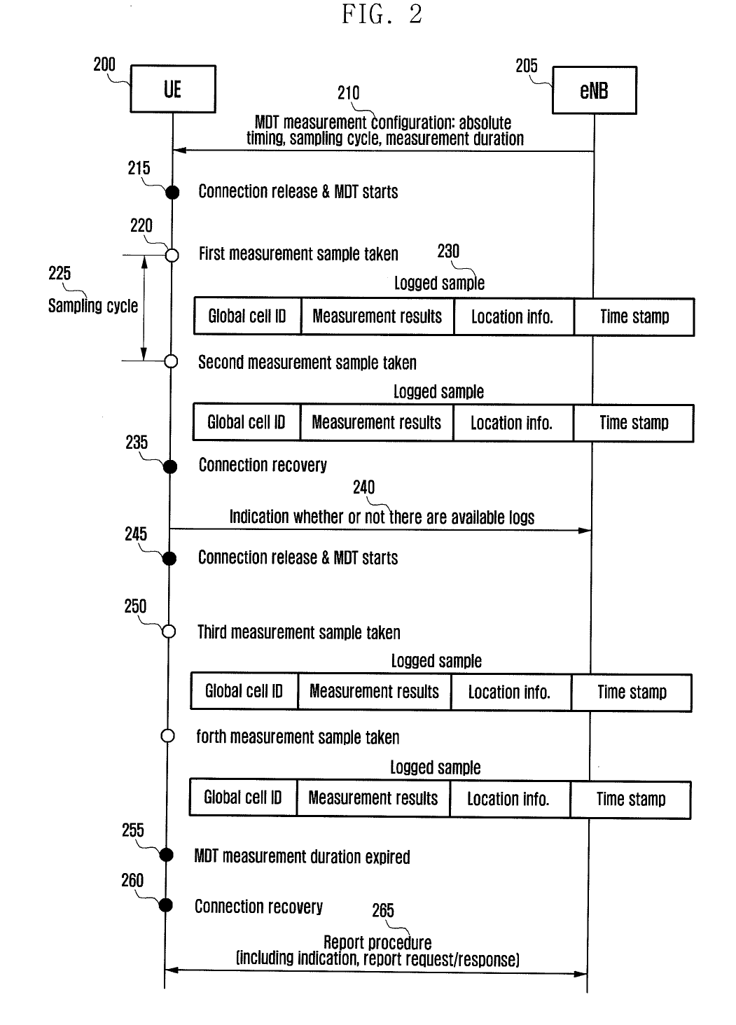

FIG. 2 is a signaling diagram illustrating an MDT measurement process of a deferred measurement report procedure according to an exemplary embodiment of the present invention.

Referring to FIG. 2, the eNB 205 sends the eNB in connected mode the information necessary for MDT configuration, i.e., MDT configuration information in step 210. The MDT configuration information includes the absolute reference time information, sampling cycle, and measurement duration. The absolute reference time has been described above. The sampling cycle is used for measuring the periodic downlink pilot signal. The MDT measurement information is collected and recorded at a predetermined cycle. The measurement duration is the total time for performing MDT. Once the measurement duration has elapsed, the UE 200 stops MDT measurement. When the RRC state of the UE 200 transitions from the connected mode to the idle mode, the UE 200 starts MDT measurement in step 215. After the completion of the first MDT measurement and recording in step 220, the UE 200 continues performing MDT measurement and recording at the predetermined sampling cycle in step 225. In step 230, the UE records the MDT measurement information described above for each measured sample. When the RRC state transitions from the idle mode to the connected mode in step 235, the UE 200 notifies the eNB of whether the recorded MDT measurement information is available (i.e., available logs) in step 240. The eNB can request the report according to the situation. If the eNB requests the report, the UE reports the MDT measurement information recorded until then and deletes all the reported information. If the eNB does not request the report, the UE continues recording the MDT measurement information.

If the UE 200 enters the idle mode in step 245 and the measurement duration has not elapsed, the UE 200 continues MDT operation in step 250 to collect the MDT measurement information. The measurement duration may be considered for the time in connected mode. When the measurement duration expires in step 255, the UE 200 stops the MDT measurement. If the UE 200 transitions to the connected mode at step 260, the UE 200 notifies the eNB of the recoded MDT measurement information and performs a reporting procedure in response to the request from the eNB at step 265.

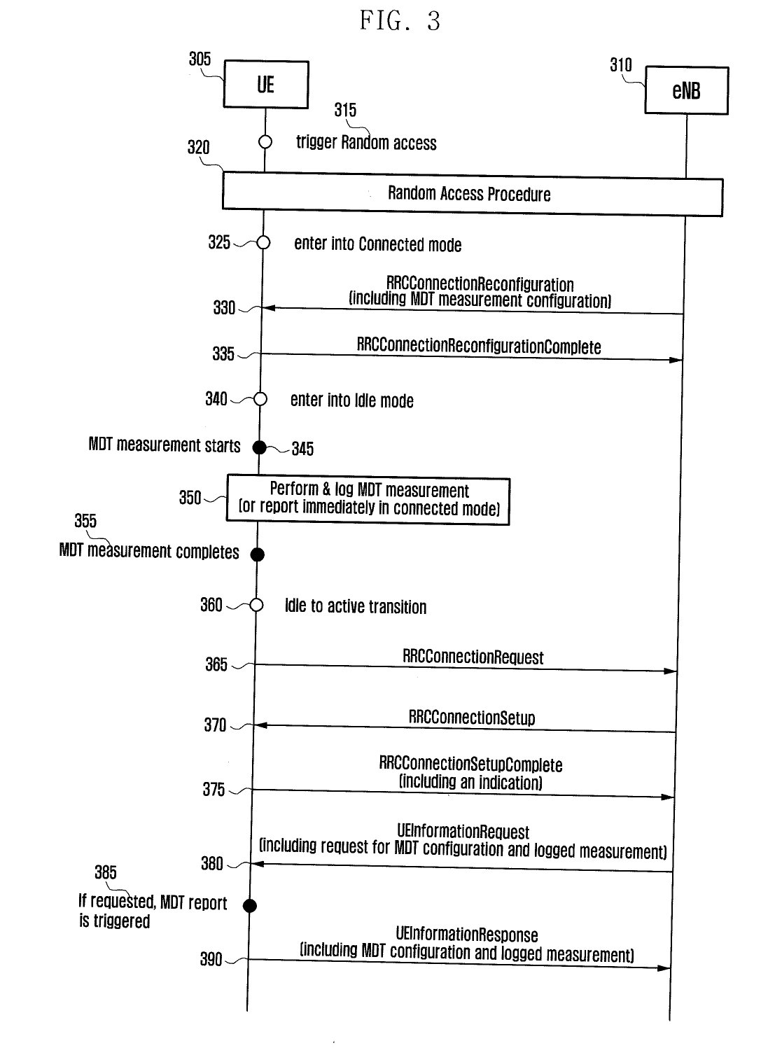

FIG. 3 is a signaling diagram illustrating a procedure for reporting recorded channel measurement information in response to a request of an eNB according to an exemplary embodiment of the present invention.

Referring to FIG. 3, the UE 305 triggers a random access process in step 315 and attempts random access to the network in step 320. The UE 305 enters the connected mode in step 325. The eNB 310 sends the UE 305 the information used for MDT, i.e., the channel measurement configuration information, through the RRC connection reconfiguration (RRCConnectionReconfiguration) message in step 330. The UE 305 sends the eNB 310 an RRC connection reconfiguration complete (RRCConnectionReconfigurationComplete) message in response to the RRCConnectionReconfiguration message in step 335.

The UE 305 transitions to the idle mode in step 340. If the MDT measurement duration is started in step 345, the UE 305 performs MDT measurement in step 350 until the MDT measurement duration is completed in step 355. The UE 305 determines transition to the connected mode in step 360 and sends the eNB an RRC Connection Request (RRCConnectionRequest) message in step 365. If the RRC connection is allowed, the eNB 310 sends the UE 305 an RRC Connection Setup (RRCConnectionSetup) message in step 370. After transition to the connected mode, the UE 305 notifies the eNB 310 of the existence of the channel measurement information recorded in the idle mode in step 375. For this purpose, an identifier is transmitted in an RRC Connection Setup Complete (RRCConnectionSetupComplete) message. The identifier is transmitted to notify the eNB 310 of where the UE 305 has the recorded MDT measurement information to be reported such that the eNB 310 can determine whether to request the MDT measurement information. Typically, if the UE 305 stays in idle mode for a relatively long time, a large amount of channel measurement information is accumulated. If the UE transitions to the connected mode in such a state, the UE 305 has to consume a large amount of resources for the transmission of the recorded information. The eNB 310 determines whether to request for the MDT measurement information in consideration of current radio capacity status.

If it is determined that the channel measurement information recorded by the UE 305 is useful, the eNB 310 requests the UE 305 to report the MDT measurement information by transmitting a UE Information Request (UEInformationRequest) message in step 380. Upon receipt of the UE Information Request message, the UE 305 sends the eNB 310 the MDT measurement information in step 385. Typically, it is not required to transmit the recorded MDT measurement information urgently, and so the MDT measurement information transmission may be attempted in consideration of the priorities of other RRC messages and normal data. The UE transmits MDT measurement information to the eNB 310 in a UE Information Response (UEInformationResponse) message in step 390. The UE 305 may delete the MDT measurement information which is already reported to the eNB 310.

Exemplary embodiments of the present invention propose the use of information recorded and reported by the UE supporting MDT in connected/idle mode. Exemplary embodiments of the present invention define the processes for transmitting the location information acquisition time along with the location information in connected mode to verify the validity of the corresponding information and for recording the measurement information at the cell reselection time point in idle mode and the indicator informing of the type of cell reselection. Exemplary embodiments of the present invention propose a method for transmitting the location information acquisition time along with the UE location information in connected mode efficiently in order to verify the corresponding information.

The MDT reports may be categorized into an immediate MDT report performed in connected mode and a logged MDT report performed in idle mode.

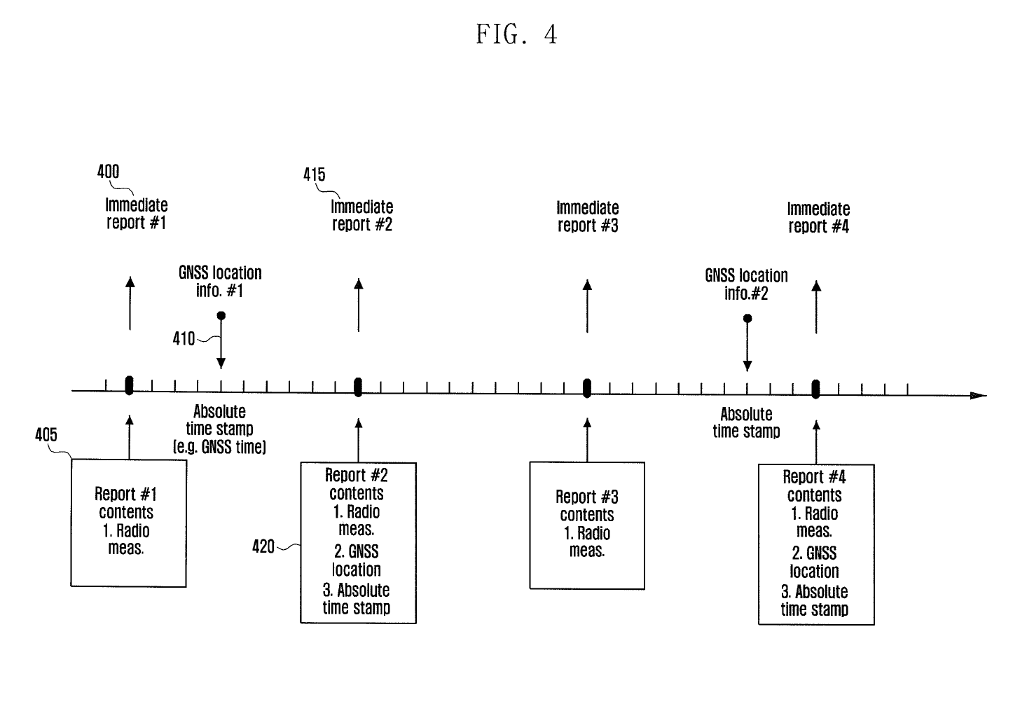

FIG. 4 is a diagram illustrating a principle of an immediate MDT report for collecting and reporting location information according to an exemplary embodiment of the present invention.

Referring to FIG. 4, when the UE is instructed to perform the periodic report, the UE reports the collected MDT measurement information to the eNB at a predetermined interval as denoted by reference numbers 400 and 415. If the Global Navigation Satellite Systems (GNSS) location information is not collected, the UE reports only the MDT measurement information at the immediate report time as denoted by reference number 405. If the GNSS location information is collected, the UE reports the MDT measurement information along with the location information to the eNB at the next immediate report time point as denoted by reference number 420.

While the UE may not always transmit the location information, the UE does verify the location information. The validity of the location information indicates the relationship of the location information to the time of MDT measurement information report. The eNB wants to know the location of the UE when the measurement information is reported. Accordingly, if the difference between the location information acquisition time and the report time is great, the probability of a difference between the location where the UE has reported the measurement information and the location where the measurement information is acquired is high. Accordingly, when there is a large difference between the information acquisition time point and the information report time point, the UE may transmit the measurement information with the location information at the next report time.

Whether to transmit the location information may be configured according to the UE implementation. If it is determined to include the location information in the report, the UE reports the location information acquisition time along with the MDT measurement information and location information at the next report time as denoted by reference number 420. The time information may be acquired when the GNSS location information is collected. The time point is used for the eNB to verify the location information. Although the UE generally verifies the location information, the eNB may also verify the GNSS location information again based on the time information.

In the connected mode, the UE performs immediate MDT report so as to report the MDT measurement information to the eNB immediately. In the connected mode, the UE may collect the GNSS location information. Once the GNSS location information is collected, the UE may determine the time information at the time when the GNSS location information is acquired. The UE may report the GNSS location information and time information to the eNB along with the MDT measurement information collected in connected mode. The UE may report the GNSS location information and time information at the arriving MDT measurement information report time after the time when the GNSS location information is acquired. The UE may also compare the GNSS location information acquisition time and the MDT measurement information report time to determine the validity of the GNSS location information and then report the GNSS location information and time information only when the GNSS location information is valid. If the GNSS location information and time information are received, the eNB may determine the time when the GNSS location information is acquired. Accordingly, the eNB compares the GNSS location information acquisition time point and the MDT measurement information report time point to verify the GNSS location information again and use the GNSS location information when the GNSS location information is valid. If no GNSS location information is acquired in connected mode, the UE reports the MDT measurement information to the eNB.

Exemplary embodiments of the present invention define processes for the UE to record the measurement information at the cell reselection time point in idle mode. In the idle mode, the UE records the measurement information periodically. In the connected mode, the UE reports the measurement information periodically or when the channel Quality of Service (QoS) (e.g., Reference Signal Received Power (RSRP)/Reference Signal Received Quality (RSRQ)) falls below a predetermined threshold value. Such record and report events are not enough for providing information necessary for service area optimization. In order to optimize the service area, the information recorded at the cell reselection time point may be useful. The cell reselection is a process for reselecting the serving cell in order for the UE to connect to the cell having the best channel state. At the cell reselection time, the service area changes and thus it may be very useful to add such information. The UE records the Enhanced universal mobile telecommunications system (umts) terrestrial radio access network (utran) Cell Global Identifier (E-CGI) and RSRP and RSRQ information of the serving cell, PCI and RSRP and RSRQ information of the neighbor cell, time information on recording time point, and location information at the recording time point. In addition, the UE may further record an indicator informing of the cell reselection event. If the UE provides the eNB with the type of cell reselection occurred by the UE rather than just the indicator information of the cell reselection occurrence, this information may be further useful for the eNB to optimize the service area. The cell reselection may be classified into one of three categories:

Cell reselection to higher priority frequency or Radio Access Technology (RAT)

Cell reselection to same priority frequency or intra-frequency cell

Cell reselection to lower priority frequency or RAT.

In the cell reselection process, one of the three cell reselection types is determined based on the frequency priority information. If the UE notifies the eNB of the cell reselection type, the eNB may determine which frequency or RAT is providing the strongest signal at the corresponding time. The cell reselection type indication may be useful information for serving area optimization.

The priority information on the frequency may be broadcast through System Information Block (SIB) or transmitted to a specific UE through dedicated signaling. The frequency priority information influences when the UE measures a specific frequency. For frequencies having a priority higher than that of the current serving cell, the UE always performs measurement. The intra-frequency identical with that of the serving cell or other frequencies equal to or lower in priority is excluded in measurement, in order to save UE power. The measurement is performed when the channel QoS of the serving cell is equal to or less than a predetermined threshold value. The cell reselection is performed to move to a cell having a good channel condition and thus there is no reason for the UE to move to a frequency having equal or lower priority when the current serving cell has good channel QoS.

In order to reduce the power consumption caused by unnecessary channel measurement, it is determined whether to perform the channel measurement with a predetermined threshold value. In case of intra-frequency, when the QoS of the serving cell is equal to or less than the threshold value Sintrasearch, the channel measurement is performed to other cell(s) of the same frequency. In case of frequencies having an equal or lower priority, when the QoS of the serving cell is equal to or less than the threshold value Sintrasearch, the channel measurement is performed to the corresponding cells of other frequency. Typically, the channel QoS includes RSRP and RSRQ.

If the channel QoS of the cell using the frequency having higher priority becomes higher than a predetermined threshold (ThreshX-high) while performing the channel measurement, the UE reselects the cell using the frequency having the higher priority as the serving cell. If the channel QoS of the cell using a priority having the low priority is higher than the threshold value (ThreshX-low) and the QoS of the serving cell becomes lower than the ThreshServing-low, the UE reselects the cell using the frequency having the low priority as the serving cell. The individual cells having the same frequency or the frequencies having the same priority determines the priority according to a specific rule based on the channel QoS. This is referred to as cell ranking.

The ranking value of the serving cell is defined as Rs=Qmeas,s+Qhyst,s. The ranking value of the neighbor cell is defined as Rn=Qmeas,n+Qoffs,n. Qmeas,s and Qmeas,n are RSRP values of the serving cell and neighbor cell. Qhyst,s is the hysteresis value applied to the serving cell, and Qoffs,n is the offset value between the serving cell and the neighbor cell. If the ranking value of a cell is great, the corresponding cell is selected as the serving cell.

If the cell reselection is performed through the above described process, the UE records the measurement information at the corresponding time point for MDT report along with the indicator informing of the type of cell reselection.

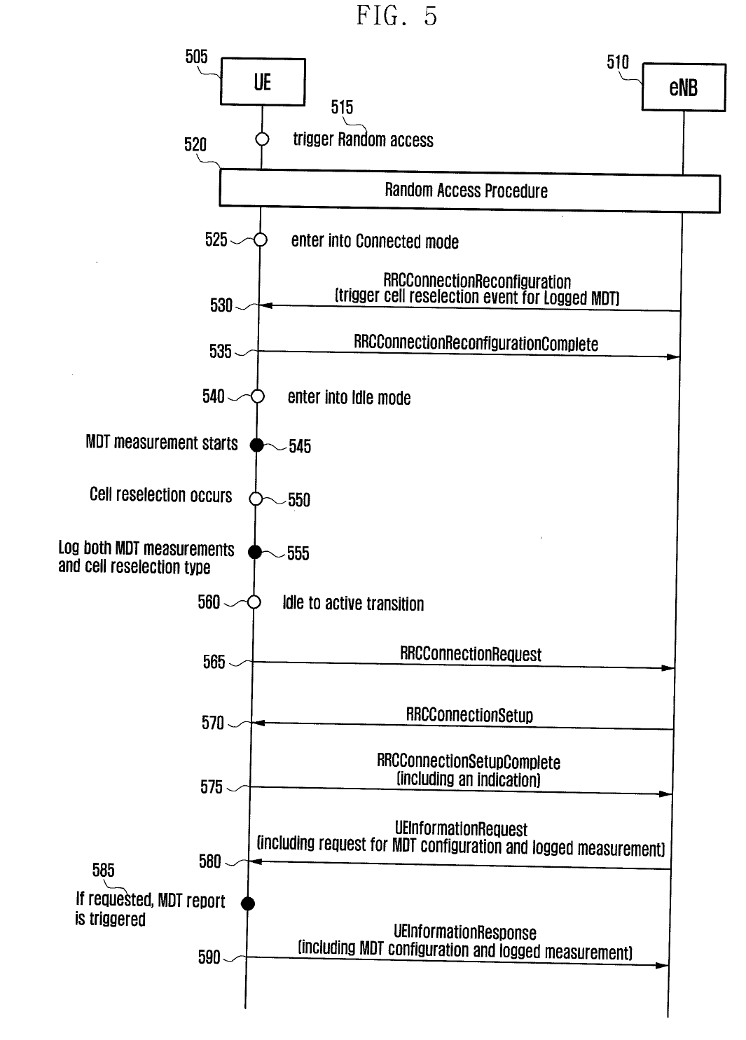

FIG. 5 is a signaling diagram illustrating a procedure for UE to record channel measurement information and cell reselection type and report the recorded information to an eNB according to an exemplary embodiment of the present invention.

Referring to FIG. 5, the UE 505 triggers random access in step 515 to establish a connection to the network through random access procedure in step 520. The UE 505 enters the connected mode in step 525. Once the UE 505 enters the connected mode, the eNB 510 sends the UE 505 an RRC connection reconfiguration (RRCConnectionReconfiguration) message including the MDT-related information, i.e., the channel measurement configuration information, in step 530. The UE 505 sends the eNB 510 an RRCConnectionReconfigurationComplete message in response to the RRCConnectionReconfiguration message in step 535.

The UE 505 enters the idle mode in step 540 and performs MDT measurement at the MDT measurement timing in step 545. The UE performs cell reselection while moving in step 550. The cell reselection is one of the following three types:

Cell reselection to higher priority frequency or RAT

Cell reselection to same priority frequency or intra-frequency cell

Cell reselection to lower priority frequency or RAT.

The UE 505 records the MDT measurement information and the type of the cell reselection in step 555. When the RRC state of the UE 505 transitions from the connected mode to the idle mode in step 560, the UE 505 sends the eNB 510 an RRC connection request message (RRCConnectionRequest) message in step 565. If the eNB 510 accepts the RRC connection, the eNB 510 sends the UE 505 an RRC connection setup (RRCConnectionSetup) message in step 570. The UE 505 in connected mode notifies the eNB 510 of the existence of the channel measurement information recorded in idle mode in step 575. For this purpose, the eNB 510 sends the UE 505 an RRC connection setup complete (RRCConnectionSetupComplete) message including a channel measurement information indicator.

The channel measurement information indicator is transmitted to notify the eNB 510 of the existence of the MDT measurement information to report in order for the eNB 510 to determine whether to request for the MDT measurement information. Since the UE 505 stays in idle mode as long as possible to save power, there is likely to a large amount of channel measurement information recorded in the idle mode. In this state, when the RRC state of the UE 505 transitions from the idle mode to the connected mode, it is necessary for the UE 505 to consume relatively large amount of resources to transmit the recorded information. Accordingly, the eNB 510 determines whether to request for the MDT measurement information report in consideration of the current radio capacity environment. If it is necessary to receive the channel measurement information recorded by the UE 505, the eNB 510 sends the UE 505 a UE information request (UEInformationRequest) message to request the MDT measurement information in step 580. Upon receipt of the UEInformationRequest message, the UE 505 prepares the MDT report to the eNB 510 in step 585. Since the recorded MDT measurement information is not typically urgent, whether to request the transmission is determined in consideration of the priorities of other RRC messages and normal data. Finally, the UE 505 sends the eNB 510 a UE information response (UEInformationResponse) message including the MDT measurement information in step 590. The UE 505 may delete the reported MDT measurement information from the memory.

The UE 505 in idle mode records the MDT measurement information for the logged MDT report. The UE 505 records the MDT measurement information at an interval corresponding to the sampling cycle. The UE 505 in idle mode further records the MDT measurement information at the time of cell reselection. The type of the cell reselection is recorded along with the MDT measurement information. In the idle mode cell reselection, the UE 505 determines the type of the cell reselection and records the information for identifying the cell reselection type. If the RRC state of the UE 505 transitions from the idle mode to the connected mode, the UE 505 may report the MDT measurement information and the type of cell reselection to the eNB 510.

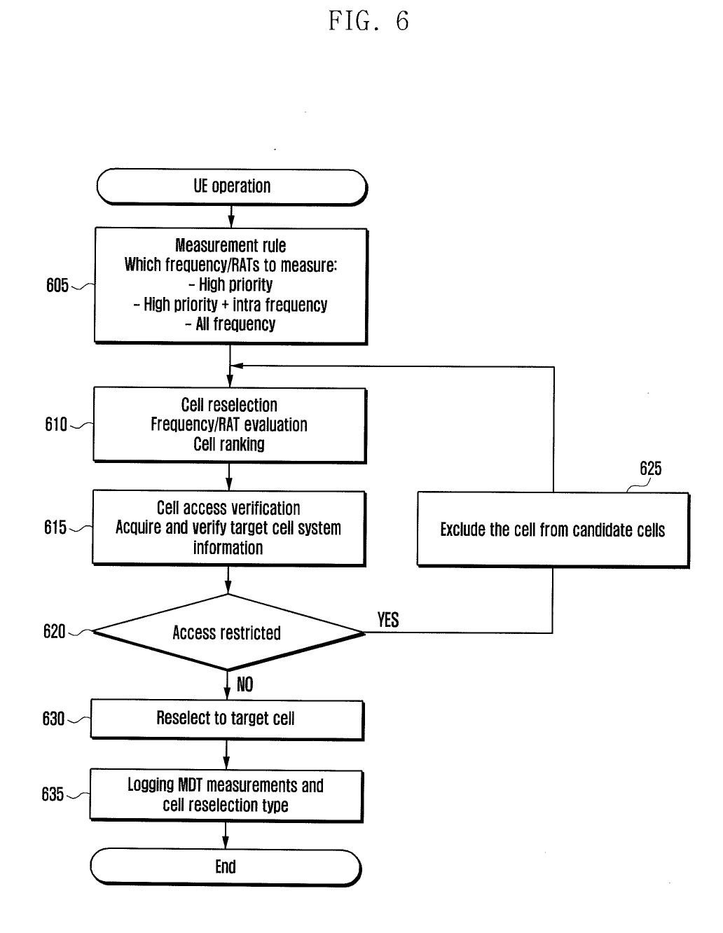

FIG. 6 is a flowchart illustrating a procedure for UE to report MDT measurement information according to an exemplary embodiment of the present invention.

Referring to FIG. 6, the UE monitors the frequency channels in step 605. The priority information on the frequencies and RATs are broadcast or transmitted to the UE through dedicated signaling. Frequencies having a higher priority than that of the current frequency are always monitored. Frequencies having priority equal to that of the intra-frequency are monitored when the QoS of the serving cell falls below a first predetermined threshold value. Frequencies having low priority are also monitored when the QoS of the serving cell falls below a second predetermined threshold value. Typically, the first threshold value is less than the second threshold value. In this manner, the UE determines whether cell reselection is necessary. If the cell reselection is necessary, the UE determines the type of the cell reselection. The UE determines the cell to be reselected according a predetermined rule in step 610. The rule has been described above. In the cell reselection process, the UE determines whether each of the reselectable cells is prohibited for access. The access prohibited cell list is broadcast by the serving cell. The UE determines whether the cell is restricted for access in step 620. If the target cell is restricted for access, the UE excludes the corresponding cell from the candidate reselectable cells. The UE verifies the reselectable cells again. If the target cell is not restricted for access, the UE performs reselection to the corresponding cell. After the cell reselection, the UE records the channel measurement information and type of the cell reselection immediately at the cell reselection time point in step 635.

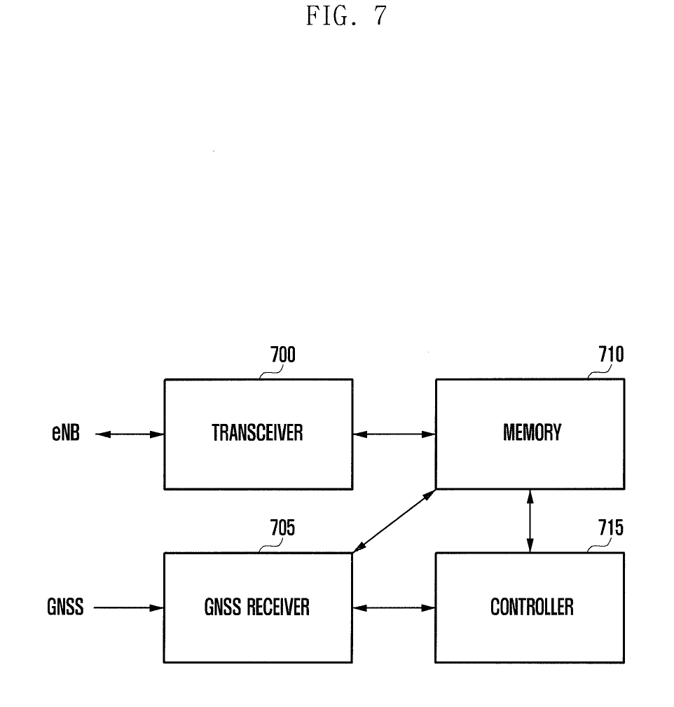

FIG. 7 is a block diagram illustrating a configuration of a UE according to an exemplary embodiment of the present invention.

Referring to FIG. 7, the UE includes a transceiver 700, a GNSS receiver 705, a controller 715, and a memory 710. The UE may also include additional components not shown here for the sake of clarity.

The transceiver 700 is responsible for receiving MDT configuration information from the eNB and for collecting MDT measurement information. The GNSS receiver 705 is responsible for collecting the GNSS location information of the UE and time information. The controller 715 controls to collect and report the MDT measurement information to the eNB. The controller 715 may record the type of cell reselection along with the MDT measurement information at the cell reselection time point in idle mode. The controller 715 may also report the GNSS location information and time information along with the MDT measurement information in the connected mode. The memory 710 stores the MDT measurement information.

The controller 715 in idle mode performs the logged MDT to collect the MDT measurement information. The controller 715 records the MDT measurement information at an interval corresponding to the sampling cycle. The controller 715 further records the MDT measurement information at the cell reselection timing in idle mode. The controller 715 records the type of cell reselection along with the MDT measurement information. In the idle mode cell reselection process, the controller 715 determines the type of the cell reselection and records the cell reselection type information. If the RRC state of the UE transitions from the idle mode to the connected mode, the controller 715 reports the MDT measurement information and the type of cell reselection to the eNB.

In the connected mode, the controller 715 performs the immediate MDT to report the collected MDT measurement information to the eNB immediately. In the connected mode, the controller 715 may also connect the GNNS location information. If the GNSS location information is acquired, the controller 715 may acquire the time information at the GNSS location information acquisition time point. Accordingly, the controller 715 may report the MDT measurement information to the eNB along with the GNSS location information and time information in the connected mode. The UE may report the GNSS location information and time information at the MDT measurement information time report time arriving right after the time when the GNSS location information is acquired. The controller 715 compares the GNSS location information acquisition time and the MDT measurement information report time to verify the GNSS location information and reports the GNSS location and time information only when the GNSS location information is valid. If no GNSS location information is collected in the connected mode, the controller 715 reports the MDT measurement information to the eNB without GNSS location information.

Although not depicted in the drawings, the eNB includes a transceiver and a controller. The transceiver is responsible for communication with the UE. The transceiver transmits the MDT configuration information to the UE and receives the MDT measurement information transmitted by the UE. The controller controls the MDT measurement information request and receipt of the MDT measurement information transmitted by the UE.

As described above, the method and apparatus for controlling measurement information in 3GPP system according to the exemplary embodiments of the present invention allows the UE to provide the eNB with supplementary information in addition to the MDT measurement information such that the eNB can use the MDT measurement information more efficiently with the assistant of the supplementary information.

While the invention has been shown and described with reference to certain exemplary embodiments thereof, it will be understood by those skilled in the art that various changes and details may be made therein without departing from the spirit and scope of the invention as defined by the appended claims and their equivalents.

What is claimed is:

1. An information control method of a terminal, the method comprising:
measuring Minimization of Drive Test (MDT) information while the terminal is in an idle mode; and
recording the MDT information when the terminal performs cell reselection in the idle mode.

2. The method of claim 1, wherein the recording of the MDT information comprises recording a type of the cell reselection.

3. The method of claim 1, further comprising reporting, when the terminal transitions from the idle mode to a connected mode, the recorded MDT information.

4. The method of claim 3, further comprising:
collecting location information in the connected mode; and
reporting the location information along with MDT information measured in the connected mode.

5. The method of claim 4, wherein the reporting of the location information and the MDT information comprises reporting a time when the location information is acquired.

6. An information control apparatus of a terminal, the apparatus comprising:
a controller for measuring Minimization of Drive Test (MDT) information while the terminal is in an idle mode and for recording the MDT information when the terminal performs cell reselection in the idle mode; and
a memory for storing the recorded MDT information.

7. The apparatus of claim 6, wherein the controller records a type of the cell reselection along with the measured MDT information.

8. The apparatus of claim 6, further comprising a transceiver for transmitting, when the terminal transitions from the idle mode to connected mode, the recorded MDT information.

9. The apparatus of claim 8, further comprising:
a location receiver for collecting location information in the connected mode,
wherein the controller reports, when the location information is collected, MDT information measured in the connected mode along with the location information.

10. The apparatus of claim 9, wherein the controller further reports a time point the location information is acquired along with the MDT information.

11. An information reception method of a base station, the method comprising:
requesting Minimization of Drive Test (MDT) information recorded in an idle mode from a terminal; and
receiving the recorded MDT information along with a type of cell reselection performed by the terminal,
wherein the terminal measures the MDT information in the idle mode, records the MDT information and the type of the cell reselection when the terminal performs the cell reselection in the idle mode, and reports the recorded MDT information along with the type of the cell reselection when the terminal transitions from the idle mode to a connected mode.

12. The method of claim 11, further comprising receiving location information on the location where the terminal measures the MDT information in the connected mode and time information on a time point when the location information is acquired,
wherein the terminal reports, when the location information is acquired in the connected mode, the MDT information along with the location information and the time information.

13. An apparatus of a base station, the apparatus comprising:
a transceiver for communicating with a terminal; and
a controller for requesting Minimization of Drive Test (MDT) information recorded in an idle mode from a terminal, and for receiving the MDT information along with a type of cell reselection performed by the terminal,
wherein the terminal measures the MDT information in the idle mode, records the MDT information and the type of the cell reselection when the terminal performs the cell reselection in the idle mode, and reports the recorded MDT information along with the type of the cell reselection when the terminal transitions from the idle mode to a connected mode.

14. The apparatus of claim 13, wherein the controller receives location information on a location where the terminal measures the MDT information in connected mode and time information on a time when the location information is acquired,
wherein the terminal reports, when the location information is acquired in the connected mode, the MDT information along with the location information and the time information.
